(19) United States
(12) Patent Application Publication
(10) Pub. No.: US 2025/0164904 A1
(43) Pub. Date: May 22, 2025

(54) OPTICAL SCANNING DEVICE AND IMAGE FORMING APPARATUS

(71) Applicant: KYOCERA Document Solutions Inc., Osaka (JP)

(72) Inventors: Takaaki MURASE, Osaka (JP); Ryotaro TODOKORO, Osaka (JP)

(73) Assignee: KYOCERA Document Solutions Inc., Osaka (JP)

(21) Appl. No.: 18/948,177

(22) Filed: Nov. 14, 2024

(30) Foreign Application Priority Data
Nov. 22, 2023 (JP) 2023-198112

(51) Int. Cl. G03G 15/043; G02B 26/12

(52) U.S. Cl. CPC G03G 15/0435; G02B 26/125; G03G 2215/0404

(57) ABSTRACT

An optical scanning device includes a light source, a deflector, and a first lens and a second lens. A light beam from the light source strikes a deflection surface on the deflector obliquely in the sub-scanning direction. For the first and second lenses, the shapes of their entrance and exit surfaces with respect to the light beam are defined by a main scanning direction shape formula and a sub-scanning direction shape formula that include different coefficients for one and the other sides with respect to the middle in the main scanning direction. The sub-scanning direction shape formula includes, as a variable, a sub-scanning direction curvature radius defined by a sub-scanning direction curvature radius definition formula. The sub-scanning direction curvature radius definition formula is given by a polynomial with a coordinate in the main scanning direction as a variable, and includes a first order term of the variable.

### INCORPORATION BY REFERENCE

This application is based on and claims the benefit of priority from Japanese Patent Application No. 2023-198112 filed on Nov. 22, 2023, the contents of which are hereby incorporated by reference.

### BACKGROUND

The present disclosure relates to optical scanning devices and to image forming apparatuses.

Electrophotographic type image forming apparatuses such as copiers and printers may include an optical scanning device used to expose to light the surface of a photosensitive drum, which is an image carrying member, while scanning them with a light beam so as to form an electrostatic latent image on the surface of the photosensitive drum. For optical scanning devices, various techniques have been developed to enhance their imaging performance.

### SUMMARY

According to one aspect of the present disclosure, an optical scanning device includes a light source, a deflector, and a first lens and a second lens. The light source emits a light beam. The deflector has a deflection surface that deflects the light beam. The first lens and the second lens are arranged on the optical path of the light beam deflected by the deflector, and extend in the main scanning direction and the sub-scanning direction of the light beam. The light beam passes through the first and second lenses in this order. The light source is arranged at a position where the light beam strikes the deflection surface obliquely in the sub-scanning direction. For the first and second lenses, the shapes of their entrance and exit surfaces with respect to the light beam are defined by a main scanning direction shape formula and a sub-scanning direction shape formula that include different coefficients for one and the other sides with respect to the middle in the main scanning direction. The sub-scanning direction shape formula includes, as a variable, a sub-scanning direction curvature radius defined by a sub-scanning direction curvature radius definition formula. The sub-scanning direction curvature radius definition formula is given by a polynomial with a coordinate in the main scanning direction as a variable, and includes a first order term of the variable.

### BRIEF DESCRIPTION OF THE DRAWINGS

FIG. 1 is a schematic sectional side view of an image forming apparatus according to an embodiment of the present disclosure.

FIG. 2 is a schematic sectional side view of an optical scanning device in the image forming apparatus in FIG. 1.

FIG. 3 is a perspective view of the optical scanning device in FIG. 2.

FIG. 4 is a sectional view showing the locations of a light source and a deflector in the optical scanning device in FIG. 2.

FIG. 5 is a top view showing a schematic configuration of a first and a second lens in the optical scanning device in FIG. 2.

FIG. 6 is a schematic perspective view illustrating the generatrix shape of the first and second lenses in the optical scanning device in FIG. 2.

FIG. 7 is an illustrative diagram showing incident light striking the deflector in the optical scanning device in FIG. 2.

FIG. 8 is an illustrative diagram showing the incident light striking the first and second lenses in the optical scanning device in FIG. 2.

FIG. 9 is a graph showing the irradiation position in the sub-scanning direction in the optical scanning devices of the embodiment and a comparative example.

FIG. 10 is a graph showing the relationship between the position in the main scanning direction and the light beam diameter in the main scanning direction in the comparative example.

FIG. 11 a graph showing the relationship between the position in the main scanning direction and the light beam diameter in the main scanning direction in the embodiment.

FIG. 12 is a graph showing the relationship between the position in the main scanning direction and the light beam diameter in the sub-scanning direction in the comparative example.

FIG. 13 is a graph showing the relationship between the position in the main scanning direction and the light beam diameter in the sub-scanning direction in the embodiment.

FIG. 14 is a graph showing, on an enlarged scale, a middle part of the graph in FIG. 12.

FIG. 15 is a graph showing, on an enlarged scale, a middle part of the graph in FIG. 13.

### DETAILED DESCRIPTION

Hereinafter, an embodiment of the present disclosure will be described with reference to the drawings. The present disclosure is not limited to the following descriptions.

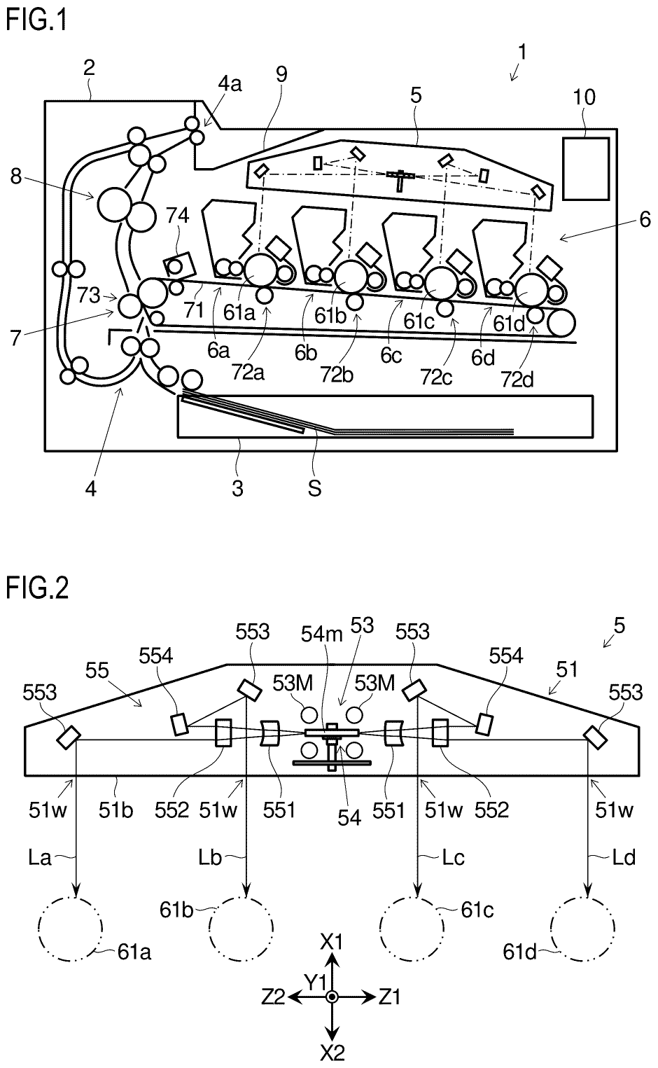

FIG. 1 is a schematic sectional side view of an image forming apparatus 1 according to an embodiment. One example of the image forming apparatus 1 according to this embodiment is a tandem color printer that receives image data according and print instructions for a print job from an external computer and that then transfers a toner image to a sheet S by using an intermediate transfer belt 71. The image forming apparatus 1 may be, for example, what is called a multifunction peripheral having functions such as printing, scanning (image reading), and facsimile transmission.

As shown in FIG. 1, the image forming apparatus 1 includes, in its main body 2, a sheet feeding portion 3, a sheet conveyance portion 4, an optical scanning device 5, an image forming portion 6, a transfer portion 7, a fixing portion 8, a sheet discharging portion 9, and a control portion 10.

The sheet feeding portion 3 is arranged in a bottom part of the main body 2. The sheet feeding portion 3 stores a plurality of unprinted sheets (recording medium) S and feeds out the sheets S one by one during printing. The sheet conveyance portion 4 extends along a side wall of the main body 2 in the up-down direction. The sheet conveyance portion 4 conveys the sheet S fed out from the sheet feeding portion 3 to a secondary transfer portion 73 and then to the fixing portion 8, and after that discharges the sheet S after fixing through a sheet discharging port 4a to the sheet discharging portion 9.

The optical scanning device 5 is arranged in a top part of the main body 2. The optical scanning device 5 irradiates the image forming portion 6 with laser light controlled based on image data. The configuration of the optical scanning device 5 will be described in detail later.

The image forming portion 6 is arranged below the optical scanning device 5, above the intermediate transfer belt 71. The image forming portion 6 includes an image forming portion 6a for yellow, an image forming portion 6b for cyan, an image forming portion 6c for magenta, and an image forming portion 6d for black. These four image forming portions 6 have basically a similar structure. Therefore, in the following description, unless distinction is required, the suffixes “a”, “b”, “c”, and “d” distinguishing different colors may be omitted.

The image forming portion 6 includes a photosensitive drum (image carrying member) 61 that is supported so as to be rotatable in a predetermined direction (counter-clockwise in FIG. 1). The image forming portion 6 further includes, arranged around the photosensitive drum 61 along its rotation direction, a charging portion, a development portion, and a drum cleaning portion. Between the development portion and the drum cleaning portion, a primary transfer portion 72 is arranged.

The photosensitive drum 61 has a photosensitive layer formed on its outer circumferential surfaces. The charging portion electrostatically charges the outer circumferential surface of the photosensitive drum 61 to a predetermined surface potential. The optical scanning device 5 shines light onto the outer circumferential surface of the photosensitive drum 61 electrostatically charged by the charging portion, and forms on the outer circumferential surface of the photosensitive drum 61 an electrostatic latent image of a document image with the charge attenuated. The development portion feeds toner to the electrostatic latent image on the outer circumferential surface of the photosensitive drum 61 to develop it into a toner image. The four image forming portions 6 form toner images of different colors. The drum cleaning portion removes and collects the toner and other deposit that, after the toner image is primarily transferred to the outer circumferential surface of the intermediate transfer belt 71, remains on the outer circumferential surface of the photosensitive drum 61. In this way, the image forming portion 6 forms an image (toner image) that is subsequently transferred to the sheet S.

The transfer portion 7 includes a primary transfer portions 72a, 72b, 72c, and 72d, and a secondary transfer portion 73, and a belt cleaning portion 74. The intermediate transfer belt 71 is arranged below the four image forming portions 6, above the sheet feeding portion 3. The intermediate transfer belt 71 is supported so as to be rotatable in a predetermined direction (clockwise in FIG. 1) and is an endless intermediate transferring member to which the toner images formed on the outer circumferential surface of the photosensitive drum 61 in the four image forming portions 6 are, while being sequentially overlaid on each other, primarily transferred. The four image forming portions 6 are arranged in what is called a tandem formation in which they are lined up in a row from upstream to downstream in the rotation direction of the intermediate transfer belt 71.

The primary transfer portions 72a, 72b, 72c, and 72d are arranged below the image forming portions 6a, 6b, 6c, and 6d of the different colors, across the intermediate transfer belt 71. The secondary transfer portion 73 is arranged upstream of the fixing portion 8 in the sheet conveyance direction of the sheet conveyance portion 4, downstream of the four image forming portions 6a, 6b, 6c, and 6d in the rotation direction of the intermediate transfer belt 71. The belt cleaning portion 74 is arranged downstream of the secondary transfer portion 73 in the rotation direction of the intermediate transfer belt 71.

The primary transfer portion 72 transfers the toner image formed on the outer circumferential surface of the photosensitive drum 61 to the outer circumferential surface of the intermediate transfer belt 71. In other words, the toner images are primarily transferred to the outer circumferential surface of the intermediate transfer belt 71 in the primary transfer portion 72a, 72b, 72c, and 72d of the different colors. As the intermediate transfer belt 71 rotates, the toner images in the four image forming portions 6 are sequentially transferred to the intermediate transfer belt 71 so as to be overlaid on each other with predetermined timing so that, on the outer circumferential surface of the intermediate transfer belt 71, a color toner image is formed that has the toner images of four colors, namely yellow, cyan, magenta, and black, overlaid on each other.

The color toner image on the outer circumferential surface of the intermediate transfer belt 71 is transferred to the sheet S synchronously conveyed by the sheet conveyance portion 4, at a secondary transfer nip portion formed in the secondary transfer portion 73. The belt cleaning portion 74 cleans the outer circumferential surface of the intermediate transfer belt 71 by removing toner and other deposit remaining on it. In this way, the transfer portion 7 transfers (records) to the sheet S the toner image formed on the outer circumferential surface of the photosensitive drum 61.

The fixing portion 8 is arranged above the secondary transfer portion 73. The fixing portion 8 heats and presses the sheet S having the toner image transferred to it to fix the toner image to the sheet S.

The sheet discharging portion 9 is arranged above the transfer portion 7. The sheet S having the toner image fixed to it and having completed printing is conveyed to the sheet discharging portion 9. In the sheet discharging portion 9, the printed sheet (printed matter) is taken out from above.

The control portion 10 includes a CPU, an image processing portion, a storage portion, and other electronic circuits and electronic components (of which none is illustrated). The CPU, based on a control program and data stored in the storage portion, controls the operation of different components in the image forming apparatus 1 to perform processes related to the functions of the image forming apparatus 1. The sheet feeding portion 3, the sheet conveyance portion 4, the optical scanning device 5, the image forming portion 6, the transfer portion 7, and the fixing portion 8 each receive instructions individually from the control portion 10 and cooperate to print on the sheet S. The storage portion is configured as, for example, a combination of a non-volatile storage device such as a program ROM (read-only memory) and a data ROM, and a volatile storage device such as a RAM (random-access memory).

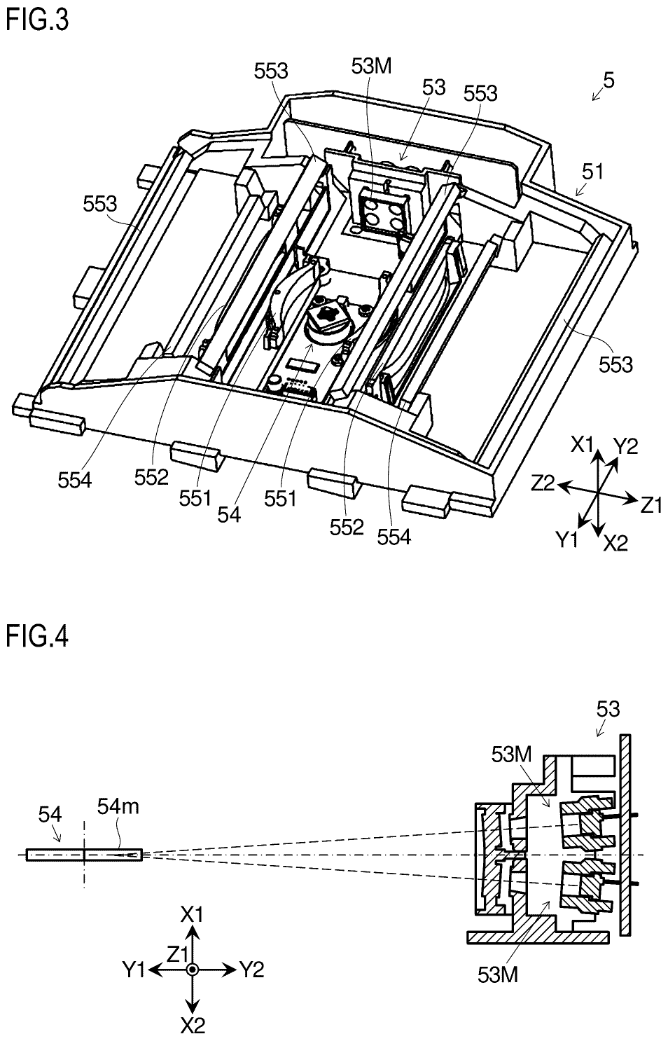

Next, the configuration of the optical scanning device 5 will be described with reference to FIGS. 2 to 6. FIG. 2 is a schematic sectional side view of the optical scanning device 5 in the image forming apparatus 1 in FIG. 1. FIG. 3 is a perspective view of the optical scanning device 5 in FIG. 2. FIG. 4 is a sectional view showing the locations of a light source 53 and a deflector 54 in the optical scanning device 5 in FIG. 2.

In this description, for convenience' sake, the main scanning direction is taken as the Y direction (the front-rear direction with respect to the plane of FIG. 2), the sub-scanning direction is taken as the X direction (the up-down direction in FIG. 2), and the traveling direction of light with respect to the deflector 54 is taken as the Z direction (the left-right, longitudinal direction in FIG. 2). The X, Y, and Z directions are orthogonal to each other. The Y direction, which is the main scanning direction, has the reflection point of the light on the deflector 54 as the origin, the direction from the deflector 54 opposite to the direction in which the light source 53 is located being the Y1 direction and the direction from the deflector 54 toward the light source 53 being the Y2 direction. The X direction, which is the sub-scanning direction, coincides with the direction in which the rotation axis of the deflector 54 extends. With respect to each of the deflector 54, a first lens 551, and a second lens 552, the X direction has the middle point of its length in the sub-scanning direction as the origin, one direction (for example, the upward direction in FIG. 2) with respect to the origin being the X1 direction and the other direction (for example, the downward direction in FIG. 2) being the X2 direction. For the Z direction, the one direction with respect to the deflector 54 is the Z1 direction and the other direction, that is, the opposite direction, is the Z2 direction.

The optical scanning device 5 is used to expose to light the outer circumferential surfaces of the photosensitive drums 61a, 61b, 61c, and 61d in the image forming portions 6a, 6b, 6c, and 6d of different colors while scanning them with a light beam so as to form electrostatic latent images on those outer circumferential surfaces.

As shown in FIGS. 2 and 3, the optical scanning device 5 includes a housing 51, the light source 53, the deflector 54, and an optical member 55.

The housing 51 is formed in the shape of a bottomed box with an opening at one side in the X direction (the sub-scanning direction, the up-down direction in FIG. 2), at the top side in FIG. 2. The opening of the housing 51 is closed with a cover member (not shown). In FIG. 3, the cover member is omitted from illustration. The cover member is formed substantially in a plate shape and is attached to the opening of the housing 51 to cover the inner space of the optical scanning device 5.

The housing 51 houses the light source 53, the deflector 54, and the optical member 55. In a bottom part 51b of the housing 51, windows 51w are arranged in which light-transmitting members (not shown) are provided. Through the windows 51w pass light beams La, Lb, Lc, and Ld, which will be described later, emitted from the light source 53 as they travel toward the surfaces to be scanned of the photosensitive drums 61a, 61b, 61c, and 61d.

The light source 53 is arranged inside the housing 51, for example, near the side wall of the housing 51. The light source 53 has, for example, a laser diode that emits a beam of laser light in the visible spectrum. The light source 53 is provided with four light-emitting modules 53M, including four independent laser diodes that emit light beams La, Lb, Lc, and Ld that are shone onto the four photosensitive drums 61a, 61b, 61c, and 61d, respectively. The light source 53 further includes a collimator lens and a cylindrical lens (neither is shown) through which the light beams La, Lb, Lc, and Ld emitted from the laser diodes.

With respect to the Z direction (the left-right, longitudinal direction in FIG. 2), of the four light-emitting modules 53M, two are arranged in the Z1 direction and the other two are arranged in the Z2 direction relative to the rotation axis of the deflector 54 at the middle. With respect to the X direction (the sub-scanning direction, the up-down direction in FIG. 2), of the four light-emitting modules 53M, two are arranged above and the other two are arranged below the middle of the sub-scanning direction of a deflection surface 54m of the deflector 54, which will be described later. That is, when viewed from the Y direction (the front-rear direction with respect to the plane of FIG. 2), the four light-emitting modules 53M are located in a substantially middle part of the housing 51 in the Z direction (the left-right, longitudinal direction in FIG. 2) to face the deflector 54, and are arranged at four places corresponding to the vertices of a quadrangular shape.

That is, as shown in FIG. 4, the light source 53 is arranged at a position where the light beams strike the deflection surface 54m obliquely in the sub-scanning direction (the X direction, the up-down direction in FIG. 4).

The light beams La, Lb. Lc, and Ld emitted from the light source 53 pass through the collimator lens and the cylindrical lens and strike the deflection surface 54m around the deflector 54. The collimator lens converts the light beams La, Lb. Lc, and Ld emitted from the light source 53 into substantially parallel light in a main scanning cross section. The cylindrical lens converges the light beams La, Lb, Lc, and Ld in the sub-scanning direction (the X direction) and condenses the light near the deflection surface 54m of the deflector 54. Thus, near the deflection surface 54m of the deflector 54, the light beams La, Lb, Lc, and Ld are formed as line images.

The deflector 54 is arranged inside the housing 51, for example, in a substantially middle part of the housing 51. The deflector 54 is a polygon mirror configured in a regular polygonal shape in a plan view and is provided with, around it, a plurality of deflection surfaces (reflection surfaces) 54m that deflect light beams. The deflector 54 rotates with a motor (not shown) about an axis perpendicular to the bottom part 51b of the housing 51.

The light beams La, Lb, Lc, and Ld emitted from the light source 53 strike the deflection surface 54m around the deflector 54 infinitesimal angular deviations in the normal direction (the sub-scanning direction (the X direction), the up-down direction in FIG. 2) with respect to the bottom part 51b. The deflector 54 deflects the light beams La, Lb, Le, and Ld emitted from the light source 53 on the deflection surface 54m. Specifically, the deflector 54, while rotating, reflects the light beams La, Lb, Lc, and Ld on its deflection surface 54m and guides them to the optical member 55 while deflecting them in the main scanning direction (the Y direction).

The optical member 55 is arranged inside the housing 51, on the optical paths of the light beams La, Lb, Lc, and Ld deflected (reflected) by the deflector 54. The optical member 55 includes, for example, the first lens 551, the second lens 552, and reflection mirrors 553 and 554. The first and second lenses 551 and 552 and the reflection mirrors 553 and 554 extend in the main scanning direction (the Y direction) of the light beams La, Lb, Lc, and Ld.

The first and second lenses 551 and 552 are both what is called a fθ lens that deflects the light beams La, Lb, Lc, and Ld reflected on the deflector 54 at a uniform speed in the main scanning direction (the Y direction). The light beams La, Lb, Lc, and Ld pass through the first and second lenses 551 and 552 in this order.

The reflection mirrors 553 and 554 change the optical paths of the light beams La, Lb, Lc, and Ld. Specifically, the reflection mirror 553 reflects the light beams La, Lb, Lc, and Ld in a predetermined direction to let them pass through the windows 51w and reach the surfaces of the photosensitive drums 61a, 61b, 61c, and 61d, which are the surfaces to be scanned, so that they form images there. The reflection mirror 554 is arranged on the optical paths of the light beams Lb and Lc. The reflection mirror 554 guides the light beams Lb and Lc having passed through the first and second lenses 551 and 552 to the reflection mirror 553.

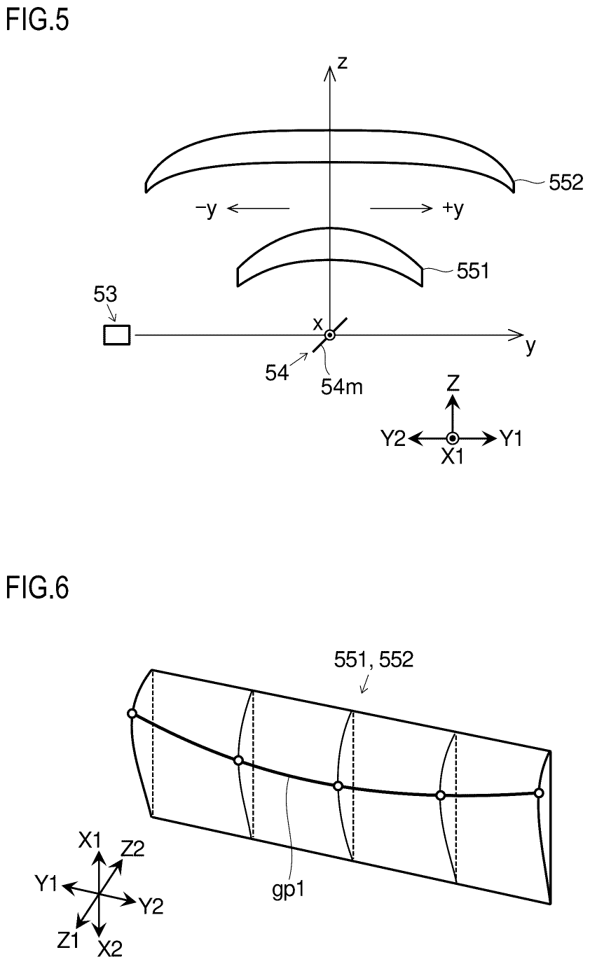

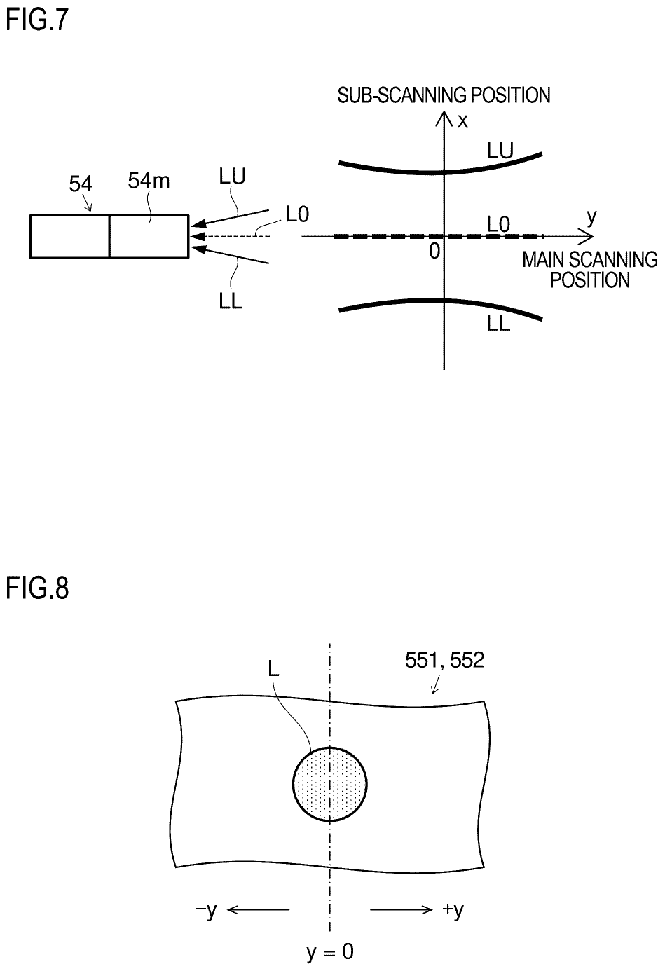

Next, the configuration of the optical scanning device 5 will be described in detail. FIG. 5 is a top view showing a schematic configuration of the first and second lenses 551 and 552 in the optical scanning device 5 in FIG. 2. FIG. 6 is a schematic perspective view illustrating the generatrix shape of the first and second lenses 551 and 552 in the optical scanning device 5 in FIG. 2. FIG. 7 is an illustrative diagram showing incident light striking the deflector 54 in the optical scanning device 5 in FIG. 2. FIG. 8 is an illustrative diagram showing the incident light striking the first and second lenses 551 and 552 in the optical scanning device 5 in FIG. 2. In the following description, the light beams La, Lb, Lc, and Ld may be called simply “the light beam L”.

As shown in FIG. 5, the light beam L emitted from the light source 53 is deflected (reflected) on the deflection surface 54m of the deflector 54 and passes through the first and second lenses 551 and 552 in this order. In the following description, assuming that the main scanning direction (the Y direction) has the origin (0) at the reflection point of the light on the deflector 54, the direction from the deflector 54 opposite to the direction in which the light source 53 is located, that is, the Y1 direction, may be called the +Y side (plus Y side) and the direction from the deflector 54 toward the light source 53, that is, the Y2 direction, may be called the −Y side (minus Y side).

For the first and second lenses 551 and 552, which are a fθ lens, the shapes of their entrance and exit surfaces with respect to the light beam L are defined by the following formulas (1) to (12). Formulas (1) to (6) define the surface shape in the −Y side region in the main scanning direction (the Y direction), and formulas (7) to (12) define the surface shape in the +Y side region in the main scanning direction (the Y direction).

$$\begin{matrix}[ Formula 1 ] & \\ Zm\_m = \frac{{y}^{2} / rm\_m}{1 + \sqrt{1 - ( 1 + km\_m ) {( y / rm\_m )}^{2}}} + {A\_m}_{4} {y}^{4} + {A\_m}_{6} {y}^{6} + {A\_m}_{8} {y}^{8} + {A\_m}_{10} {y}^{10} & ( 1 )\end{matrix}$$

$$Zs\_m = \frac{{( x - x\_m )}^{2} / rs\_m}{1 + \sqrt{1 - ( 1 + ks\_m ) {( ( x - x\_m ) / rs\_m )}^{2}}} \qquad ( 2 )$$

$$rs\_m = {rs\_m}_{0} + {B\_m}_{1} y + {B\_m}_{2} {y}^{2} + {B\_m}_{4} {y}^{4} + {B\_m}_{6} {y}^{6} + {B\_m}_{8} {y}^{8} + {B\_m}_{10} {y}^{10} \qquad ( 3 )$$

$$ks\_m = {ks\_m}_{0} + {ks\_m}_{2} {y}^{2} + {ks\_m}_{4} {y}^{4} + {ks\_m}_{6} {y}^{6} + {ks\_m}_{8} {y}^{8} + {ks\_m}_{10} {y}^{10} \qquad ( 4 )$$

$$x\_m = {C\_m}_{0} + {C\_m}_{2} {y}^{2} + {C\_m}_{4} {y}^{4} + {C\_m}_{6} {y}^{6} + {C\_m}_{8} {y}^{8} + {C\_m}_{10} {y}^{10} \qquad ( 5 )$$

$$Z\_m = Zm\_m + Zs\_m \qquad ( 6 )$$

$$\begin{matrix}[ Formula 2 ] & \\ Zm\_p = \frac{{y}^{2} / rm\_p}{1 + \sqrt{1 - ( 1 + km\_p ) {( y / rm\_p )}^{2}}} + {A\_p}_{4} {y}^{4} + {A\_p}_{6} {y}^{6} + {A\_p}_{8} {y}^{8} + {A\_p}_{10} {y}^{10} & ( 7 )\end{matrix}$$

$$Zs\_p = \frac{{( x - x\_p )}^{2} / rs\_p}{1 + \sqrt{1 - ( 1 + ks\_p ) {( ( x - x\_p ) / rs\_p )}^{2}}} \qquad ( 8 )$$

$$rs\_p = {rs\_p}_{0} + {B\_p}_{1} y + {B\_p}_{2} {y}^{2} + {B\_p}_{4} {y}^{4} + {B\_p}_{6} {y}^{6} + {B\_p}_{8} {y}^{8} + {B\_p}_{10} {y}^{10} \qquad ( 9 )$$

$$ks\_p = {ks\_p}_{0} + {ks\_p}_{2} {y}^{2} + {ks\_p}_{4} {y}^{4} + {ks\_p}_{6} {y}^{6} + {ks\_p}_{8} {y}^{8} + {ks\_p}_{10} {y}^{10} \qquad ( 10 )$$

$$x\_p = {C\_p}_{0} + {C\_p}_{2} {y}^{2} + {C\_p}_{4} {y}^{4} + {C\_p}_{6} {y}^{6} + {C\_p}_{8} {y}^{8} + {C\_p}_{10} {y}^{10} \qquad ( 11 )$$

$$Z\_p = Zm\_p + Zs\_p \qquad ( 12 )$$

Formula (1) is a main scanning direction shape formula for the first and second lenses 551 and 552 in the main scanning direction −Y side region and Zm_m represents the main scanning direction sag amount in the −Y side region. In Formula (1), rm_m represents the main scanning direction curvature radius, km_m represents the main scanning direction conic constant, and A_m₄ to A_m₁₀ represent aspheric coefficients. Formula (2) is a sub-scanning direction shape formula for the first and second lenses 551 and 552 in the main scanning direction −Y side region and Zs_m represents the sub-scanning direction sag amount in the −Y side region. Formula (3) is a sub-scanning direction curvature radius definition formula for the first and second lenses 551 and 552 in the main scanning direction −Y side region and rs_m represents the sub-scanning direction curvature radius in the −Y side region. In Formula (3), B_m₁ to B_m₁₀ represent coefficients. Formula (4) is a sub-scanning direction conic constant definition formula for the first and second lenses 551 and 552 in the main scanning direction −Y side region and ks_m represents the sub-scanning direction conic constant in the −Y side region. Formula (5) is a sub-scanning direction generatrix position definition formula for the first and second lenses 551 and 552 in the main scanning direction −Y side region and x_m represents the sub-scanning direction generatrix position in the −Y side region. In Formula (5), C_m₂ to C_m₁₀ represent coefficients. As shown in FIG. 6, the sub-scanning direction generatrix position gp1 is curved in the sub-scanning direction (the X direction). Formula (6) is a total sag amount definition formula for the first and second lenses 551 and 552 in the main scanning direction −Y side region and Z_m represents the total sag amount in the −Y side region.

Formula (7) is a main scanning direction shape formula for the first and second lenses 551 and 552 in the main scanning direction +Y side region and Zm_p represents the main scanning direction sag amount in the +Y side region. In Formula (7), rm_p represents the main scanning direction curvature radius, km_p represents the main scanning direction conic constant, and A_p₄ to A_p₁₀ represent aspheric coefficients. Formula (8) is a sub-scanning direction shape formula for the first and second lenses 551 and 552 in the main scanning direction +Y side region and Zs_p represents the sub-scanning direction sag amount in the +Y side region. Formula (9) is a sub-scanning direction curvature radius definition formula for the first and second lenses 551 and 552 in the main scanning direction +Y side region and rs_p represents the sub-scanning direction curvature radius in the +Y side region. In Formula (9), B_p₁ to B_p₁₀ represent coefficients. Formula (10) is a sub-scanning direction conic constant definition formula for the first and second lenses 551 and 552 in the main scanning direction +Y side region and ks_p represents the sub-scanning direction conic constant in the +Y side region. Formula (11) is a sub-scanning direction generatrix position definition formula for the first and second lenses 551 and 552 in the main scanning direction +Y side region and x_p represents the sub-scanning direction generatrix position in the +Y side region. In Formula (11), C_p₂ to C_p₁₀ represent coefficients. As in the −Y side region, the sub-scanning direction generatrix position is curved in the sub-scanning direction (the X direction) (see FIG. 6). Formula (12) is a total sag amount definition formula for the first and second lenses 551 and 552 in the main scanning direction +Y side region and Z_p represents the total sag amount in the +Y side region.

In the main scanning direction shape formulas (formulas (1) and (7)) for the −Y side and +Y side regions, the main scanning direction radii of curvature are equal to each other (rm_m=rm_p) and the main scanning direction conic constants are equal to each other (km_m=km_p). In the sub-scanning direction curvature radius definition formulas (formulas (3) and (9)) for the −Y side and +Y side regions, the zeroth order terms of a position y are equal to each other (rs_m₀=rs_p₀), and the coefficients of the first order terms of the position y are equal to each other (B_m₁=B_p₁). In the sub-scanning direction conic constant definition formulas (formulas (4) and (10)) of the −Y side and +Y side regions, the zeroth order terms of the position y are equal to each other (ks_m₀=ks_p₀). In the sub-scanning direction generatrix position definition formulas (formulas (5) and (11)) of the −Y side and +Y side regions, the zeroth order terms of the position y are equal to each other (C_m₀=C_p₀).

In a left part of FIG. 7 are schematically depicted an upper incident light beam LU and a lower incident light beam LL in this embodiment that are incident on the deflection surface 54m of the deflector 54 and a light beam L0 in the comparative example that is incident parallel to the main scanning direction (the Y direction). In contrast, in a right part of FIG. 7 is shown light beam passing positions of the light beams LU, LL, and L0 on the first lens 551. In this embodiment, the upper incident light beam LU strikes the deflection surface 54m obliquely from above, so it curves to be convex downward near the middle in the main scanning direction (the Y direction). The lower incident light beam LL strikes the deflection surface 54m obliquely from below, so curves to be convex upward near the middle of the main scanning direction (the Y direction). The light beams LU and LL curve differently on the +Y and −Y sides with respect to the middle (y=0) in the main scanning direction (the Y direction).

Thus, in the main scanning direction shape formulas (formulas (1) and (7)), the sub-scanning direction shape formulas (formulas (2) and (8)), the sub-scanning direction curvature radius definition formulas (formulas (3) and (9)), the sub-scanning direction conic constant definition formulas (formulas (4) and (10)), and the sub-scanning direction generatrix position definition formulas (formulas (5) and (11)) for the −Y side and +Y side regions, except for the radii of curvature, the conic constants, the coefficients of the first order terms, and the zeroth order terms that defined to be equal as described above, the coefficients corresponding between the −Y side and +Y side regions are different values. For example, specifically, in the main scanning direction shape formulas (formulas (1) and (7)) for the −Y side and +Y side regions, the coefficients of the fourth order terms of the position y (A_m₄, A_p₄) are different from each other. Also, for example, in the sub-scanning direction curvature radius definition formulas (formulas (3) and (9)) for the −Y side and +Y side regions, the coefficients (B_m₂, B_p₂) of the second order terms of the position y are different from each other.

As described above, for the first and second lenses 551 and 552, the shapes of their entrance and exit surfaces with respect to the light beam L are defined by the main scanning direction shape formulas (formulas (1) and (7)) and the sub-scanning direction shape formulas (formulas (2) and (8)) that include different coefficients for the −Y side and +Y side regions with respect to the middle in the main scanning direction (the Y direction).

The sub-scanning direction shape formulas (formulas (2) and (8)) include, as variables, the sub-scanning direction radii of curvature (rs_m, rs_p) defined by the sub-scanning direction curvature radius definition formulas (formulas (3) and (9)). The sub-scanning direction curvature radius definition formulas (formulas (3) and (9)) are given by polynomials with the coordinate (position y) in the main scanning direction (the Y direction) as a variable, and include a first order term of the variable. Specifically, the sub-scanning direction curvature radius definition formulas (formulas (3) and (9)) for the −Y side and +Y side regions respectively include B_m₁y and B_p₁y, which are first order terms of the position y (variable).

FIG. 8 shows the state of the light beam L on the first and second lenses 551 and 552 near the middle in the main scanning direction (the Y direction). Near the middle of the first and second lenses 551 and 552 in the main scanning direction (the Y direction), light strikes each of the −Y side and +Y side regions and to be refracted and condensed.

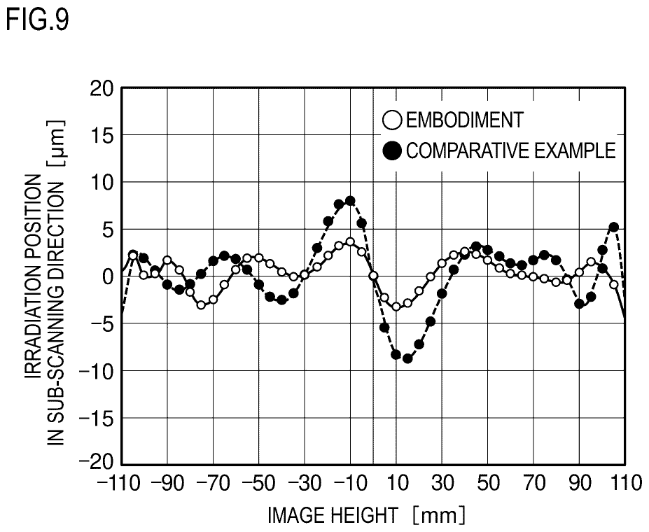

FIG. 9 is a graph showing the irradiation position in the sub-scanning direction (the X direction) in the optical scanning devices of the embodiment and the comparative example. The horizontal axis in FIG. 9 represents the image height (mm) on the lens in the main scanning direction and the vertical axis represents the irradiation position (μm) in the sub-scanning direction.

For the fθ lens in the optical scanning device of the comparative example shown in FIG. 9, the sub-scanning direction curvature radius definition formula is given by a polynomial with the coordinate in the main scanning direction as a variable and does not include the first order term of the variable. Thus, as will be understood from what is shown in FIG. 9, near the image height of 0 (mm) (near the middle in the main scanning direction) on the fθ lens in the comparative example, a large deviation occurs in the irradiation position in the sub-scanning direction and the irradiation position swings greatly to the minus and plus sides.

In contrast, the first and second lenses 551 and 552, which are the fθ lenses in the optical scanning device 5 of the embodiment shown in FIG. 9, the sub-scanning direction curvature radius definition formulas (formulas (3) and (9)) are given by a polynomial with the coordinate (position y) in the main scanning direction (the Y direction) as a variable, and include the first order terms (B_m₁y, B_p₁y) of the variable. Thus, as shown in FIG. 9, near the image height of 0 (mm) (near the middle in the main scanning direction (the Y direction)) on the first and second lenses 551 and 552 of the embodiment, no large deviation occurs in the irradiation position in the sub-scanning direction (the X direction). With the first and second lenses 551 and 552 of the embodiment, over the entire range of the image height, the irradiation position in the sub-scanning direction (the X direction) falls within relatively small swings.

With the configuration described above, where the sub-scanning direction curvature radius definition formulas (formulas (3) and (9)) are given by polynomials with the coordinate (position y) in the main scanning direction (the Y direction) as a variable and include the first order terms (B_m₁y, B_p₁y) of the variables, it is possible, near the middle of the first and second lenses 551 and 552 in the main scanning direction (the Y direction), to prevent deviation of the irradiation position in the sub-scanning direction (the X direction). This makes it possible to enhance the imaging performance of the optical scanning device 5 and to obtain suitable image quality.

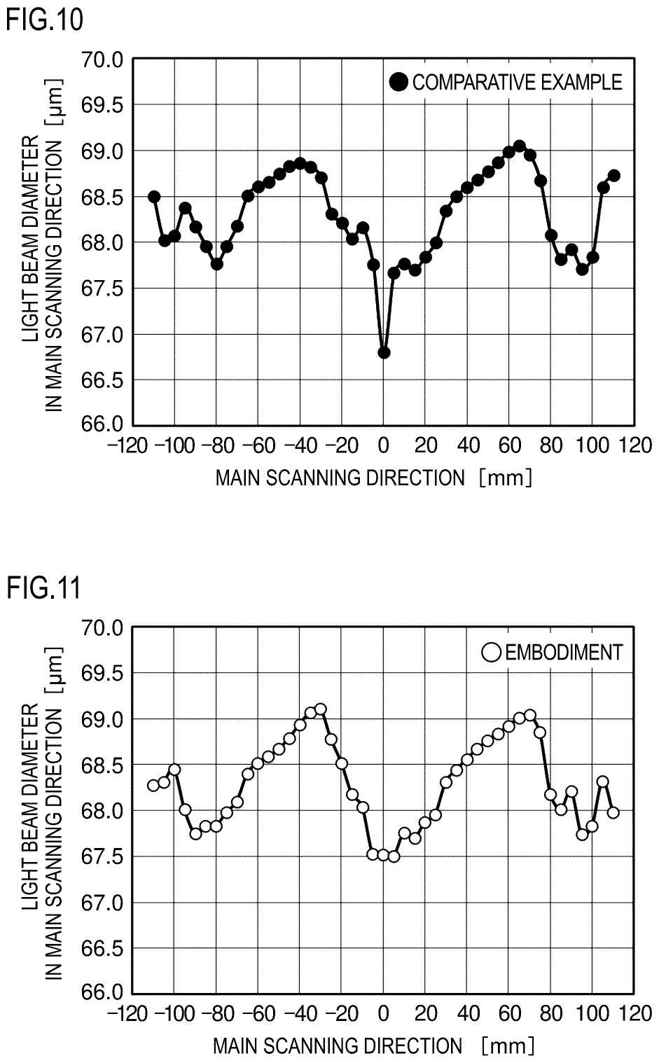

The first order terms of the sub-scanning direction curvature radius definition formulas (formulas (3) and (9)) have equal coefficients (B_m₁=B_p₁) in the −Y side and +Y side regions with respect to the middle in the main scanning direction (the X direction). This will now be described with reference to FIGS. 10 to 15.

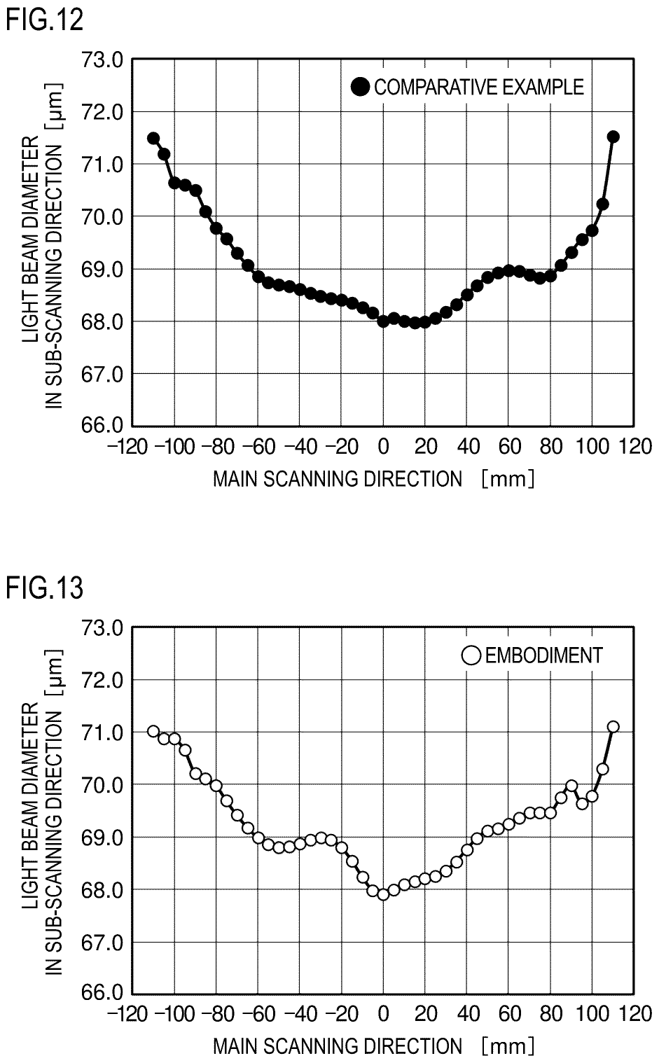

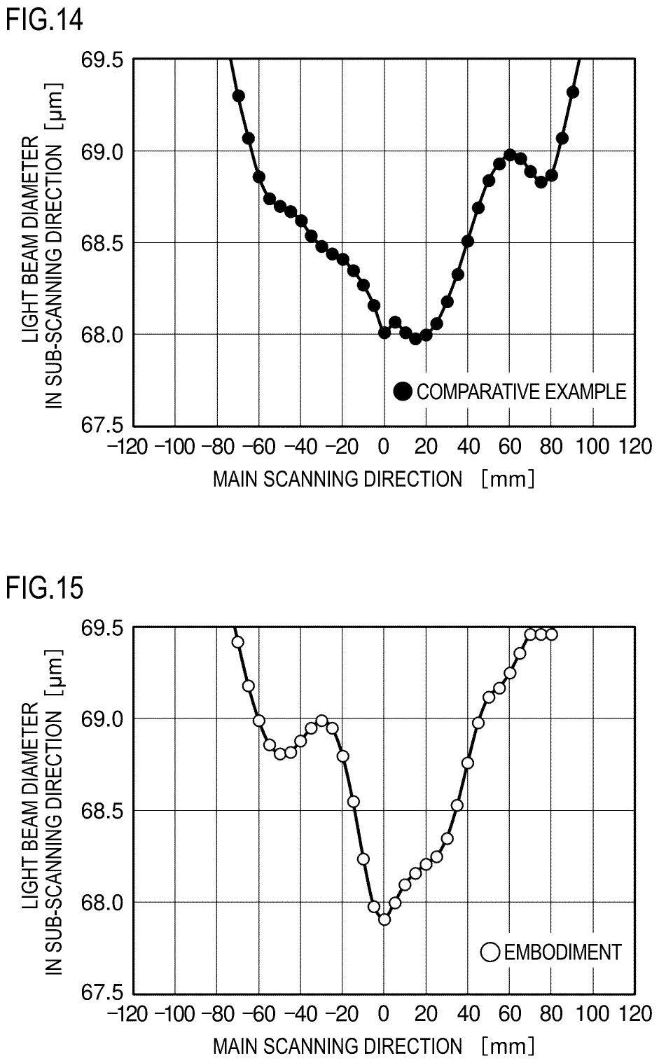

FIGS. 10 and 11 are graphs showing the relationship between the position in the main scanning direction and the light beam diameter in the main scanning direction in the comparative example and the embodiment. FIGS. 12 and 13 are graphs showing the relationship between the position in the main scanning direction and the light beam diameter in the sub-scanning direction in the comparative example and the embodiment. FIGS. 14 and 15 are graphs showing, on an enlarged scale, middle parts of the graphs in FIGS. 12 and 13. The horizontal axis in these graphs represents the position on the lens in the main scanning direction (mm) and the vertical axis represents the light beam diameter in the main scanning direction or the sub-scanning direction (μm).

For the fθ lens in the optical scanning device of the comparative example shown in FIGS. 10, 12, and 14, the first order term of the sub-scanning direction curvature radius definition formula has different coefficients between the −Y side and +Y side regions with respect to the middle in the main scanning direction. Thus, as shown in FIGS. 10 and 14, near the middle of the fθ lens in the main scanning direction in the comparative example, the size of the light beam diameter changes sharply.

In contrast, for the first and second lenses 551 and 552, which are the fθ lenses in the optical scanning device 5 of the embodiment shown in FIGS. 11, 13 and 15, the first order terms of the sub-scanning direction curvature radius definition formulas (formulas (3) and (9)) have equal coefficients (B_m₁=B_p₁) in the −Y side and +Y side regions with respect to the middle in the main scanning direction (the X direction). Thus, as shown in FIGS. 11, 13 and 15, with the first and second lenses 551 and 552 of the embodiment, over the entire range in the main scanning direction, the size of the light beam diameter changes smoothly.

With the configuration described above, where the first order terms of the sub-scanning direction curvature radius definition formulas (formulas (3) and (9)) have equal coefficients (B_m₁=B_p₁) in the −Y side and +Y side regions with respect to the middle in the main scanning direction (the X direction), over the entire range in the main scanning direction (the Y direction), it is possible to prevent local sharp changes in the size of the light beam diameter. This makes it possible to enhance the imaging performance of the optical scanning device 5 and to obtain suitable image quality.

In the sub-scanning direction curvature radius definition formulas (Formulas (3) and (9)), the orders of all terms other than the first order term are even numbers. For example, it is known that putting an odd-number order term in the sub-scanning direction curvature radius definition formulas results in smoothers changes in the curvature radius in the sub-scanning direction over the entire range in the main scanning direction. However, it is also known that, in exchange for that, local sharp changes are likely to occur in the curvature radius in the sub-scanning direction. In the configuration of the above embodiment, by making the orders of all terms other than the first order term even numbers in the sub-scanning direction curvature radius definition formulas, it is possible to give priority to coping with the suppression of local sharp changes in the curvature radius in the sub-scanning direction.

While the embodiments of the present disclosure have been described above, they are not meant to limit the scope of the present disclosure, which can thus be implemented with any modifications made without departure from the spirit of the present disclosure.

For example, in the embodiments, the first and second lenses 551 and 552 are arranged on opposite sides (Z1 and Z2 sides) of the optical scanning device 5 in the Z direction (the left-right, longitudinal direction in FIG. 2), but this is not meant as any limitation to such a configuration. The first and second lenses 551 and 552 may be arranged on only one side in the Z direction.

What is claimed is:

1. An optical scanning device comprising:
a light source that emits a light beam;
a deflector having a deflection surface that deflects the light beam; and
a first lens and a second lens that are arranged on an optical path of the light beam deflected by the deflector, the first and second lenses extending in a main scanning direction and a sub-scanning direction of the light beam, the light beam passing through the first and second lenses in this order,
wherein
the light source is arranged at a position where the light beam strikes the deflection surface obliquely in the sub-scanning direction,
for the first and second lenses, shapes of entrance and exit surfaces thereof with respect to the light beam are defined by a main scanning direction shape formula and a sub-scanning direction shape formula that include different coefficients for one side and another side with respect to a middle in the main scanning direction,
the sub-scanning direction shape formula includes, as a variable, a sub-scanning direction curvature radius defined by a sub-scanning direction curvature radius definition formula, and
the sub-scanning direction curvature radius definition formula is given by a polynomial with a coordinate in the main scanning direction as a variable, and includes a first order term of the variable.

2. The optical scanning device according to claim 1, wherein
the first order term of the sub-scanning direction curvature radius definition formula has equal coefficients in the one and the other sides with respect to the middle in the main scanning direction.

3. The optical scanning device according to claim 1, wherein
in the sub-scanning direction curvature radius definition formula, orders of all terms other than the first order term are even numbers.

4. The image forming apparatus comprising:
the optical scanning device according to claim 1, and
an image forming portion having an image carrying member of which an outer circumferential surface is irradiated with the light beam to form an electrostatic latent image.
